(19) United States
(12) Patent Application Publication
(10) Pub. No.: US 2021/0279662 A1
(43) Pub. Date: Sep. 9, 2021

(54) INTELLIGENT FACTOR BASED RESOURCE DISTRIBUTION MACHINE LOADING

(71) Applicant: Bank of America Corporation, Charlotte, NC (US)

(72) Inventor: Rebecca Stepp Morgan, Charlottesville, VA (US)

(73) Assignee: Bank of America Corporation, Charlotte, NC (US)

(21) Appl. No.: 16/809,784

(22) Filed: Mar. 5, 2020

(51) Int. Cl. G06Q 10/06; G06N 20/00; G06N 5/04; H04L 29/06; H04L 29/08

(52) U.S. Cl. CPC G06Q 10/06315; G06N 20/00; H04L 67/141; H04L 63/08; G06N 5/04

(57) ABSTRACT

Systems, computer program products, and methods are described herein for intelligent factor based resource distribution machine loading. The present invention is configured to electronically receive information associated with one or more trigger events; electronically receive, via the communication link, information associated with the one or more resource distribution machines, wherein the resource distribution machines are associated with one or more resources; implement one or more machine learning algorithms on the information associated with the one or more resource distribution machines and the information associated with the one or more trigger events; and predict a frequency at which one or more additional resources need to be added to the one or more resource distribution machines and quantity of the one or more additional resources that need to be added to the one or more resource distribution machines.

### FIELD OF THE INVENTION

The present invention embraces a system for intelligent factor based resource distribution machine loading.

### BACKGROUND

Distribution of resources are often dependent on independent and interdependent variables that affect the availability and usability of resources during specific time intervals. Therefore, there is a need for an intelligent factor based resource distribution machine loading.

### SUMMARY

The following presents a simplified summary of one or more embodiments of the present invention, in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of one or more embodiments of the present invention in a simplified form as a prelude to the more detailed description that is presented later.

In one aspect, a system for intelligent factor based resource distribution machine loading is presented. The system comprising: at least one non-transitory storage device; and at least one processing device coupled to the at least one non-transitory storage device, wherein the at least one processing device is configured to: electronically receive information associated with one or more trigger events, wherein the one or more trigger events is associated with one or more time periods, wherein the one or more trigger events is associated with a predetermined geographic region; establish a communication link with one or more resource distribution machines located within the predetermined geographic region associated with the one or more trigger events; electronically receive, via the communication link, information associated with the one or more resource distribution machines, wherein the resource distribution machines are associated with one or more resources; implement one or more machine learning algorithms on the information associated with the one or more resource distribution machines and the information associated with the one or more trigger events; and predict a frequency at which one or more additional resources need to be added to the one or more resource distribution machines and quantity of the one or more additional resources that need to be added to the one or more resource distribution machines during the one or more time periods associated with the one or more trigger events based on at least implementing the one or more machine learning algorithms.

In some embodiments, the information associated with the one or more trigger events comprises an average time period from a first time an occurrence of the one or more trigger events is predicted to occur to a second time the one or more trigger events occurs, a classification associated with the one or more trigger events, and an average time period associated with the one or more trigger events.

In some embodiments, the information associated with the one or more resource distribution machines comprises an average resource quantity available for distribution via the one or more resource distribution machines from the first time the occurrence of the one or more trigger events is predicted to occur to a third time an average predetermined time period after the one or more trigger events has concluded, a frequency at which the one or more resources were distributed via the one or more resource distribution machines during the time period between the first time and the third time, an average resource quantity distributed via the one or more resource distribution machines during the time period between the first time and the third time, an average number of users accessing the one or more resource distribution machines for distribution of the one or more resources during the time period between the first time and the third time, and an average number of resource distribution machines located within the predetermined geographic region associated with the one or more trigger events.

In some embodiments, the at least one processing device is further configured to: transmit control signals configured to cause one or more computing devices associated with one or more resource computing terminals located within a predetermined geographic distance from the one or more resource distribution machines to display the predicted frequency at which one or more additional resources need to be added to the one or more resource distribution machines and quantity of the one or more additional resources that need to be added to the one or more resource distribution machines during the one or more time periods associated with the one or more trigger events.

In some embodiments, the at least one processing device is further configured to: initiate a transmission of the predicted quantity of the one or more additional resources from the one or more resource computing terminals to the one or more resource distribution machines at the predicted frequency; and electronically receive, from the one or more resource computing terminals, an indication that the predicted quantity of the one or more additional resources have been transmitted from the one or more resource computing terminals to the one or more resource distribution machines at the predicted frequency.

In some embodiments, the one or more trigger events comprises at least one or more incidents of mass trauma.

In some embodiments, the one or more trigger events comprises one or more trigger event types, wherein the one or more trigger event types comprises at least an economic crisis, a natural disaster, a technological disaster, and/or a man-made disaster.

In some embodiments, the at least one processing device is further configured to: electronically receive, via the one or more resource distribution machines, a request to distribute the one or more resources to a user; transmit, via a display device associated with the one or more resource distribution machines, an authentication request; electronically receive, via the one or more resource distribution machines, one or more authentication credentials associated with the user in response to the authentication request; validate the one or more authentication credentials associated with the user to verify an identity of the user; and authorize distribution of the one or more resources, via the one or more resource distribution machines, to the user based on at least a successful verification of the identity of the user.

In another aspect, a computerized method for intelligent factor based resource distribution machine learning is presented. The method comprising: electronically receiving information associated with one or more trigger events, wherein the one or more trigger events is associated with one or more time periods, wherein the one or more trigger events is associated with a predetermined geographic region; establishing a communication link with one or more resource distribution machines located within the predetermined geographic region associated with the one or more trigger events; electronically receiving, via the communication link, information associated with the one or more resource distribution machines, wherein the resource distribution machines are associated with one or more resources; implementing one or more machine learning algorithms on the information associated with the one or more resource distribution machines and the information associated with the one or more trigger events; and predicting a frequency at which one or more additional resources need to be added to the one or more resource distribution machines and quantity of the one or more additional resources that need to be added to the one or more resource distribution machines during the one or more time periods associated with the one or more trigger events based on at least implementing the one or more machine learning algorithms.

In yet another aspect, a computer program product for intelligent factor based resource distribution loading is presented. The computer program product comprising a non-transitory computer-readable medium comprising code causing a first apparatus to: electronically receive information associated with one or more trigger events, wherein the one or more trigger events is associated with one or more time periods, wherein the one or more trigger events is associated with a predetermined geographic region; establish a communication link with one or more resource distribution machines located within the predetermined geographic region associated with the one or more trigger events; electronically receive, via the communication link, information associated with the one or more resource distribution machines, wherein the resource distribution machines are associated with one or more resources; implement one or more machine learning algorithms on the information associated with the one or more resource distribution machines and the information associated with the one or more trigger events; and predict a frequency at which one or more additional resources need to be added to the one or more resource distribution machines and quantity of the one or more additional resources that need to be added to the one or more resource distribution machines during the one or more time periods associated with the one or more trigger events based on at least implementing the one or more machine learning algorithms.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made the accompanying drawings, wherein:

FIG. 1 illustrates technical components of a system for intelligent factor based resource distribution loading, in accordance with an embodiment of the invention; and

FIG. 2 illustrates a process flow for intelligent factor based resource distribution machine loading, in accordance with an embodiment of the invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, a “user” may be an employee (e.g., an associate, a project manager, an IT specialist, a manager, an administrator, an internal operations analyst, or the like) of the entity or enterprises affiliated with the entity, capable of operating the systems described herein. In some embodiments, a “user” may be any individual, entity or system who has a relationship with the entity, such as a customer or a prospective customer. In other embodiments, a user may be a system performing one or more tasks described herein.

As used herein, a “user interface” may be any device or software that allows a user to input information, such as commands or data, into a device, or that allows the device to output information to the user. For example, the user interface includes a graphical user interface (GUI) or an interface to input computer-executable instructions that direct a processing device to carry out specific functions. The user interface typically employs certain input and output devices to input data received from a user second user or output data to a user. These input and output devices may include a display, mouse, keyboard, button, touchpad, touch screen, microphone, speaker, LED, light, joystick, switch, buzzer, bell, and/or other user input/output device for communicating with one or more users.

As used herein, a “resource” may generally refer to objects, products, devices, goods, commodities, services, and the like, and/or the ability and opportunity to access and use the same. Some example implementations herein contemplate property held by a user, including property that is stored and/or maintained by a third-party entity. In some example implementations, a resource may be associated with one or more accounts or may be property that is not associated with a specific account. Examples of resources associated with accounts may be accounts that have cash or cash equivalents, commodities, and/or accounts that are funded with or contain property, such as safety deposit boxes containing jewelry, art or other valuables, a trust account that is funded with property, or the like.

As used herein, a “resource transfer” or “resource distribution” may refer to any transaction, activities or communication between one or more entities, or between the user and the one or more entities. A resource transfer may refer to any distribution of resources such as, but not limited to, a payment, processing of funds, purchase of goods or services, a return of goods or services, a payment transaction, a credit transaction, or other interactions involving a user's resource or account. In the context of an entity such as a financial institution, a resource transfer may refer to one or more of: a sale of goods and/or services, initiating an automated teller machine (ATM) or online banking session, an account balance inquiry, a rewards transfer, an account money transfer or withdrawal, opening a bank application on a user's computer or mobile device, a user accessing their e-wallet, or any other interaction involving the user and/or the user's device that invokes or is detectable by the financial institution. In some embodiments, the user may authorize a resource transfer using at least a payment instrument (credit cards, debit cards, checks, digital wallets, currency, loyalty points), and/or payment credentials (account numbers, payment instrument identifiers). A resource transfer may include one or more of the following: renting, selling, and/or leasing goods and/or services (e.g., groceries, stamps, tickets, DVDs, vending machine items, and the like); making payments to creditors (e.g., paying monthly bills; paying federal, state, and/or local taxes; and the like); sending remittances; loading money onto stored value cards (SVCs) and/or prepaid cards; donating to charities; and/or the like. Unless specifically limited by the context, a “resource transfer” a “transaction”, “transaction event” or “point of transaction event” may refer to any activity between a user, a merchant, an entity, or any combination thereof. In some embodiments, a resource transfer or transaction may refer to financial transactions involving direct or indirect movement of funds through traditional paper transaction processing systems (i.e. paper check processing) or through electronic transaction processing systems. In this regard, resource transfers or transactions may refer to the user initiating a purchase for a product, service, or the like from a merchant. Typical financial transactions include point of sale (POS) transactions, automated teller machine (ATM) transactions, person-to-person (P2P) transfers, internet transactions, online shopping, electronic funds transfers between accounts, transactions with a financial institution teller, personal checks, conducting purchases using loyalty/rewards points etc. When discussing that resource transfers or transactions are evaluated it could mean that the transaction has already occurred, is in the process of occurring or being processed, or it has yet to be processed/posted by one or more financial institutions. In some embodiments, a resource transfer or transaction may refer to non-financial activities of the user. In this regard, the transaction may be a customer account event, such as but not limited to the customer changing a password, ordering new checks, adding new accounts, opening new accounts, adding or modifying account parameters/restrictions, modifying a payee list associated with one or more accounts, setting up automatic payments, performing/modifying authentication procedures and/or credentials, and the like.

As used herein, “payment instrument” may refer to an electronic payment vehicle, such as an electronic credit or debit card. The payment instrument may not be a “card” at all and may instead be account identifying information stored electronically in a user device, such as payment credentials or tokens/aliases associated with a digital wallet, or account identifiers stored by a mobile application. In accordance with embodiments of the invention, the term “module” with respect to an apparatus may refer to a hardware component of the apparatus, a software component of the apparatus, or a component of the apparatus that comprises both hardware and software. In accordance with embodiments of the invention, the term “chip” may refer to an integrated circuit, a microprocessor, a system-on-a-chip, a microcontroller, or the like that may either be integrated into the external apparatus or may be inserted and removed from the external apparatus by a user.

As used herein, “authentication credentials” may be any information that can be used to identify of a user. For example, a system may prompt a user to enter authentication information such as a username, a password, a personal identification number (PIN), a passcode, biometric information (e.g., voice authentication, a fingerprint, and/or a retina scan), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

As used herein, an “interaction” may refer to any communication between one or more users, one or more entities or institutions, and/or one or more devices, nodes, clusters, or systems within the system environment described herein. For example, an interaction may refer to a transfer of data between devices, an accessing of stored data by one or more nodes of a computing cluster, a transmission of a requested task, or the like.

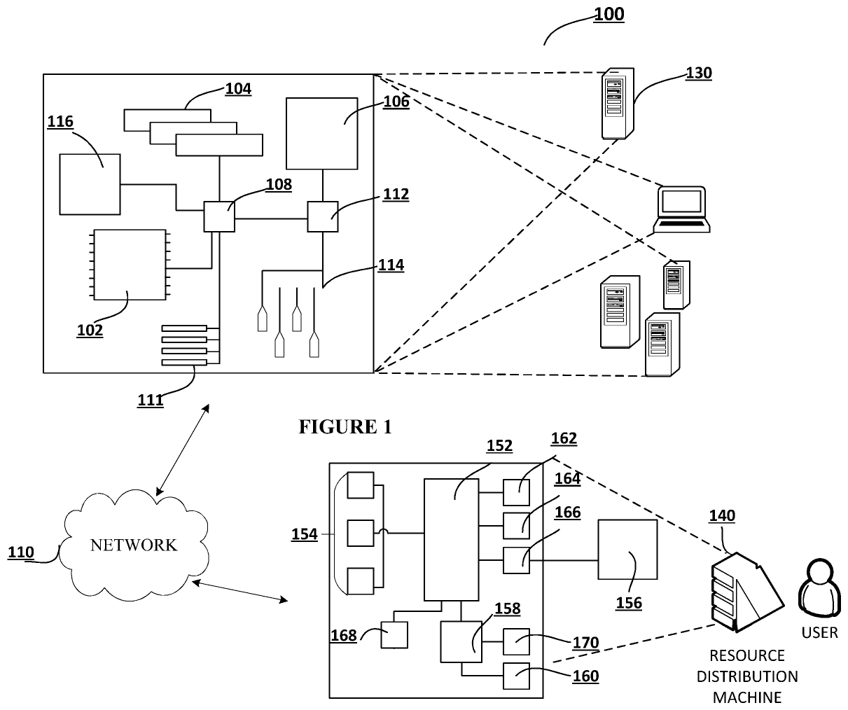

FIG. 1 presents an exemplary block diagram of the system environment for intelligent factor based resource distribution loading 100, in accordance with an embodiment of the invention. FIG. 1 provides a unique system that includes specialized servers and system communicably linked across a distributive network of nodes required to perform the functions of the process flows described herein in accordance with embodiments of the present invention.

As illustrated, the system environment 100 includes a network 110, a system 130, and one or more resource distribution machines, represented by resource distribution machine 140 in FIG. 1. Also shown in FIG. 1 is a user of the resource distribution machine 140. The resource distribution machine 140 may be a mobile device or other non-mobile computing device. In some embodiments, the resource distribution machine 140 may be an automated teller machine (ATM). The user may be a person who uses the resource distribution machine 140 to execute resource transfers using one or more applications stored on the resource distribution machine 140 and/or a user computing device (not shown) associated with the user. In some embodiments, the user may interact with the resource distribution machine 140 and/or the system 130 to execute a resource transfer. In example embodiments where the resource distribution machine 140 is an ATM, the user may interact with the ATM to execute transactions including, but not limited to, deposit or withdraw funds using an ATM, facilitate line-of-credit payments, transfers, report account information, and/or the like. The one or more applications may be configured to communicate with the system 130, execute a resource transfer, input information onto a user interface presented on the resource distribution machine 140, or the like. The applications stored on the resource distribution machine 140 and the system 130 may incorporate one or more parts of any process flow described herein.

As shown in FIG. 1, the system 130, and the resource distribution machine 140 are each operatively and selectively connected to the network 110, which may include one or more separate networks. In addition, the network 110 may include a telecommunication network, local area network (LAN), a wide area network (WAN), and/or a global area network (GAN), such as the Internet. It will also be understood that the network 110 may be secure and/or unsecure and may also include wireless and/or wired and/or optical interconnection technology.

In some embodiments, the system 130 and the resource distribution machine 140 may be used to implement the processes described herein, including the device-side and server-side processes for installing a computer program from a mobile device to a computer, in accordance with an embodiment of the present invention. The system 130 is intended to represent various forms of digital computers, such as laptops, desktops, workstations, personal digital assistants, servers, blade servers, mainframes, and other appropriate computers. The resource distribution machine 140 is intended to represent various forms of computing devices capable of resource distribution such as an ATM device. The components shown here, their connections and relationships, and their functions, are meant to be exemplary only, and are not meant to limit implementations of the inventions described and/or claimed in this document.

In accordance with some embodiments, the system 130 may include a processor 102, memory 104, a storage device 106, a high-speed interface 108 connecting to memory 104, and a low-speed interface 112 connecting to low speed bus 114 and storage device 106. Each of the components 102, 104, 106, 108, 111, and 112 are interconnected using various buses, and may be mounted on a common motherboard or in other manners as appropriate. The processor 102 can process instructions for execution within the system 130, including instructions stored in the memory 104 or on the storage device 106 to display graphical information for a GUI on an external input/output device, such as display 116 coupled to a high-speed interface 108. In other implementations, multiple processors and/or multiple buses may be used, as appropriate, along with multiple memories and types of memory. Also, multiple systems, same or similar to system 130 may be connected, with each system providing portions of the necessary operations (e.g., as a server bank, a group of blade servers, or a multi-processor system). In some embodiments, the system 130 may be a server managed by the business. The system 130 may be located at the facility associated with the business or remotely from the facility associated with the business.

The memory 104 stores information within the system 130. In one implementation, the memory 104 is a volatile memory unit or units, such as volatile random access memory (RAM) having a cache area for the temporary storage of information. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like. The memory 104 may store any one or more of pieces of information and data used by the system in which it resides to implement the functions of that system. In this regard, the system may dynamically utilize the volatile memory over the non-volatile memory by storing multiple pieces of information in the volatile memory, thereby reducing the load on the system and increasing the processing speed.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer- or machine-readable storage medium, such as the memory 104, the storage device 104, or memory on processor 102.

In some embodiments, the system 130 may be configured to access, via the 110, a number of other computing devices such as a resource computing terminal (not shown). In this regard, the system 130 may be configured to access one or more storage devices and/or one or more memory devices associated with each of the other computing devices. In this way, the system 130 may implement dynamic allocation and de-allocation of local memory resources among multiple computing devices in a parallel or distributed system. Given a group of computing devices and a collection of interconnected local memory devices, the fragmentation of memory resources is rendered irrelevant by configuring the system 130 to dynamically allocate memory based on availability of memory either locally, or in any of the other computing devices accessible via the network. In effect, it appears as though the memory is being allocated from a central pool of memory, even though the space is distributed throughout the system. This method of dynamically allocating memory provides increased flexibility when the data size changes during the lifetime of an application, and allows memory reuse for better utilization of the memory resources when the data sizes are large.

The high-speed interface 1408 manages bandwidth-intensive operations for the system 130, while the low speed controller 112 manages lower bandwidth-intensive operations. Such allocation of functions is exemplary only. In some embodiments, the high-speed interface 108 is coupled to memory 104, display 116 (e.g., through a graphics processor or accelerator), and to high-speed expansion ports 111, which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms, as shown in FIG. 1. For example, it may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 140 may be made up of multiple computing devices communicating with each other.

FIG. 1 also illustrates a resource distribution machine 140, in accordance with an embodiment of the invention. The resource distribution machine 140 includes a processor 152, memory 154, an input/output device such as a display 156, a communication interface 158, and a transceiver 160, among other components. The resource distribution machine 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the resource distribution machine 140, including instructions stored in the memory 154. The processor may be implemented as a chipset of chips that include separate and multiple analog and digital processors. The processor may be configured to provide, for example, for coordination of the other components of the resource distribution machine 140, such as control of user interfaces, applications run by resource distribution machine 140, and wireless communication by resource distribution machine 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of resource distribution machine 140 with other devices. External interface 168 may provide, for example, for wired communication in some implementations, or for wireless communication in other implementations, and multiple interfaces may also be used.

The memory 154 stores information within the resource distribution machine 140. The memory 154 can be implemented as one or more of a computer-readable medium or media, a volatile memory unit or units, or a non-volatile memory unit or units. Expansion memory may also be provided and connected to resource distribution machine 140 through an expansion interface (not shown), which may include, for example, a SIMM (Single In Line Memory Module) card interface. Such expansion memory may provide extra storage space for resource distribution machine 140, or may also store applications or other information therein. In some embodiments, expansion memory may include instructions to carry out or supplement the processes described above, and may include secure information also. For example, expansion memory may be provided as a security module for resource distribution machine 140, and may be programmed with instructions that permit secure use of resource distribution machine 140. In addition, secure applications may be provided via the SIMM cards, along with additional information, such as placing identifying information on the SIMM card in a non-hackable manner. In some embodiments, the user may use the applications to execute processes described with respect to the process flows described herein. Specifically, the application executes the process flows described herein. It will be understood that the one or more applications stored in the system 130 and/or the user computing system 140 may interact with one another and may be configured to implement any one or more portions of the various user interfaces and/or process flow described herein.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer- or machine-readable medium, such as the memory 154, expansion memory, memory on processor 152, or a propagated signal that may be received, for example, over transceiver 160 or external interface 168.

In some embodiments, the user may use the resource distribution machine 140 to transmit and/or receive information or commands to and from the system 130. In this regard, the system 130 may be configured to establish a communication link with the resource distribution machine 140, whereby the communication link establishes a data channel (wired or wireless) to facilitate the transfer of data between the resource distribution machine 140 and the system 130. In doing so, the system 130 may be configured to access one or more aspects of the resource distribution machine 140, such as, a GPS device, an image capturing component (e.g., camera), a microphone, a speaker, or the like.

The resource distribution machine 140 may communicate with the system 130 (and one or more other devices) wirelessly through communication interface 158, which may include digital signal processing circuitry where necessary. Communication interface 158 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 160. In addition, short-range communication may occur, such as using a Bluetooth, Wi-Fi, or other such transceiver (not shown). In addition, GPS (Global Positioning System) receiver module 170 may provide additional navigation—and location-related wireless data to resource distribution machine 140, which may be used as appropriate by applications running thereon, and in some embodiments, one or more applications operating on the system 130.

The resource distribution machine 140 may also communicate audibly using audio codec 162, which may receive spoken information from a user and convert it to usable digital information. Audio codec 162 may likewise generate audible sound for a user, such as through a speaker, e.g., in a handset of resource distribution machine 140. Such sound may include sound from voice telephone calls, may include recorded sound (e.g., voice messages, music files, etc.) and may also include sound generated by one or more applications operating on the resource distribution machine 140, and in some embodiments, one or more applications operating on the system 130.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

It will be understood that the embodiment of the system environment illustrated in FIG. 1 is exemplary and that other embodiments may vary. As another example, in some embodiments, the system 130 includes more, less, or different components. As another example, in some embodiments, some or all of the portions of the system environment 100 may be combined into a single portion. Likewise, in some embodiments, some or all of the portions of the system 130 may be separated into two or more distinct portions.

The present invention implements machine learning algorithms on information associated with one or more trigger events to identify an amount of funds needed to be loaded into each ATM located within a geographic region affected by the trigger event. By implementing the machine learning algorithms, the system may be configured to determine when and how much funds need to be added into an ATM so that adequate funds are available for users during that time period. For example, the system determines information such as how much warning the location has, the strength of the disaster, the historic reaction to that type of disaster with that amount of warning in that location, and the like to predict the amount of funds needed in each ATM before and after the triggering event. This further allows for better prediction of ATM funding and eliminates cost associated with funding ATMs and extracting funds out of ATMs.

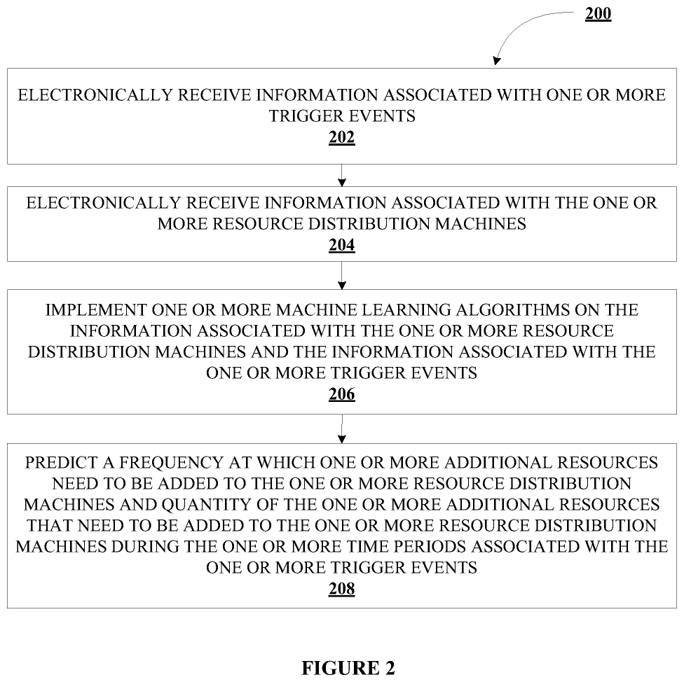

FIG. 2 illustrates a process flow for intelligent factor based resource distribution machine loading 200, in accordance with an embodiment of the invention. As shown in block 202, the process flow includes electronically receiving information associated with one or more trigger events. In some embodiments, the one or more trigger events is associated with one or more time periods. In one aspect, the one or more trigger events may be associated with one or more trigger event types including, but not limited to, economic crises, a natural disaster, a technological disaster, a man-made disaster, and/or the like. Examples of a trigger events include tornadoes and severe storms, hurricanes and tropical storms, floods, wildfires, earthquakes, drought, and/or any traumatic events that may cause exposure to life and/or property. In some embodiments, the one or more trigger events may be associated with a predetermined geographic region. Typically, a trigger event affects a particular region or a locale, affecting the population living in the area in many ways such as, causing a dramatic increase in expense, loss of energy, and/or food and services. In other words, the predetermine geographic region may be any area affected by the one or more trigger events.

In some embodiments, the information associated with the one or more trigger events may include an average time period from a first time an occurrence of the one or more trigger events is predicted to occur to a second time the one or more trigger events occurs. For purposes of this invention, the time period defined by the first time and the second time is referred to as “prediction time.” Typically, the first time, i.e., the time when an occurrence of a trigger event is predicted to occur is determined using early notification systems that are a combination of tools and processes composed of one or more elements such as knowledge of exposure to the trigger event, technical monitoring and notification service, and public awareness and preparedness to act.

In some other embodiments, the information associated with the one or more trigger events may include, but is not limited to, a classification of the one or more trigger events based on the one or more trigger events. In some other embodiments, the information associated with the one or more trigger events may be an average time period associated with the one or more trigger events. The average time period associated with the one or more trigger events may include an average time the trigger event occurs from a time an occurrence of the trigger event is first detected to a time the occurrence of the trigger event has concluded. For purposes of the invention, the time period defined by a time an occurrence of the trigger event is first detected to a time the occurrence of the trigger event has concluded is referred to as “landing time.” In some embodiments, the system may be configured to consider the prediction time in addition to the landing time when determining the average time period associated with the one or more trigger events. In some other embodiments, the system may be configured to consider a predetermined period of time after the end of the landing time when determining the average time period associated with the one or more trigger events.

Next, as shown in block 204, the process flow includes electronically receiving information associated with the one or more resource distribution machines. In some embodiments, the system may be configured to establish a communication link with one or more resource distribution machines located within the predetermined geographic region associated with the one or more trigger events. In one aspect, the system may already have an active communication link previously established with the one or more resource distribution machines. In another aspect, the system may have an existing communication link, but the link may not be an active communication link. In such situations, the system may be configured to transmit control signals configured to cause the one or more resource distribution machines to be activated, thereby establishing an active two-way communication link.

In some embodiments, the information associated with the resource distribution machines may be received and classified based on specific time intervals, such as the prediction time, the landing time, and/or the predetermined period of time after the occurrence of the trigger events. In some embodiments, the information associated with the one or more resource distribution machines may include, but is not limited to, an average resource quantity available for distribution via the one or more resource distribution machines from the first time the occurrence of the one or more trigger events is predicted to occur to a third time an average predetermined time period after the one or more trigger events has concluded, a frequency at which the one or more resources were distributed via the one or more resource distribution machines during the time period between the first time and the third time, an average resource quantity distributed via the one or more resource distribution machines during the time period between the first time and the third time, an average number of users accessing the one or more resource distribution machines for distribution of the one or more resources during the time period between the first time and the third time, and an average number of resource distribution machines located within the predetermined geographic region associated with the one or more trigger events.

In some embodiments, the information associated with the one or more resource distribution machines are based on data collected from the one or more resource distribution machines during occurrences of the one or more trigger events in the past, indicating the performance of the resource distribution machines during that time. Accordingly, in addition, the information associated with the one or more resource distribution machines may include a number of times the one or more resource distribution machines had inadequate resources for distribution. In one aspect, the number of times the resource distribution machines had inadequate resources for distribution may be determined based on a number of instances where the resource distribution machines indicated a lack of adequate resources notification to the user in response to a user request for resource distribution. In some other embodiments, the information associated with the one or more resource distribution machines may include an aggregate amount of funds that were unavailable for distribution to the users during the time period between the first time and the third time.

In some embodiments, the information associated with the one or more resource distribution machines may include an average frequency at which one or more resources are distributed to the one or more resource distribution machines and an average quantity of resources being distributed to the one or more resource distribution machines.

In some embodiments, the information associated with the one or more resource distribution machines may be received for the entire duration that the one or more resource distribution machines have remained active and distributed resources to the users.

Next, as shown in block 206, the process flow includes implementing one or more machine learning algorithms on the information associated with the one or more resource distribution machines and the information associated with the one or more trigger events. In this regard, the system may be configured to implement any of the following applicable machine learning algorithms either singly or in combination: supervised learning (e.g., using logistic regression, using back propagation neural networks, using random forests, decision trees, etc.), unsupervised learning (e.g., using an Apriori algorithm, using K-means clustering), semi-supervised learning, reinforcement learning (e.g., using a Q-learning algorithm, using temporal difference learning), and any other suitable learning style. Each module of the plurality can implement any one or more of: a regression algorithm (e.g., ordinary least squares, logistic regression, stepwise regression, multivariate adaptive regression splines, locally estimated scatterplot smoothing, etc.), an instance-based method (e.g., k-nearest neighbor, learning vector quantization, self-organizing map, etc.), a regularization method (e.g., ridge regression, least absolute shrinkage and selection operator, elastic net, etc.), a decision tree learning method (e.g., classification and regression tree, iterative dichotomiser 3, C4.5, chi-squared automatic interaction detection, decision stump, random forest, multivariate adaptive regression splines, gradient boosting machines, etc.), a Bayesian method (e.g., naïve Bayes, averaged one-dependence estimators, Bayesian belief network, etc.), a kernel method (e.g., a support vector machine, a radial basis function, a linear discriminate analysis, etc.), a clustering method (e.g., k-means clustering, expectation maximization, etc.), an associated rule learning algorithm (e.g., an Apriori algorithm, an Eclat algorithm, etc.), an artificial neural network model (e.g., a Perceptron method, a back-propagation method, a Hopfield network method, a self-organizing map method, a learning vector quantization method, etc.), a deep learning algorithm (e.g., a restricted Boltzmann machine, a deep belief network method, a convolution network method, a stacked auto-encoder method, etc.), a dimensionality reduction method (e.g., principal component analysis, partial least squares regression, Sammon mapping, multidimensional scaling, projection pursuit, etc.), an ensemble method (e.g., boosting, bootstrapped aggregation, AdaBoost, stacked generalization, gradient boosting machine method, random forest method, etc.), and any suitable form of machine learning algorithm. Each processing portion of the system 100 can additionally or alternatively leverage: a probabilistic module, heuristic module, deterministic module, or any other suitable module leveraging any other suitable computation method, machine learning method or combination thereof. However, any suitable machine learning approach can otherwise be incorporated in the system environment 100. Further, any suitable model (e.g., machine learning, non-machine learning, etc.) can be used in generating data relevant to the system 130.

Next, as shown in block 208, the process flow includes predicting a frequency at which one or more additional resources need to be added to the one or more resource distribution machines and quantity of the one or more additional resources that need to be added to the one or more resource distribution machines during the one or more time periods associated with the one or more trigger events based on at least implementing the one or more machine learning algorithms. For example, the prediction of the frequency at which one or more additional resources need to be added to the one or more resource distribution machines and quantity of the one or more additional resources that need to be added to the one or more resource distribution machines during the one or more time periods associated with the one or more trigger events may be formulated as a regression task. In this regard, the algorithm may be configured to estimate the relationship between a dependent/target variable (trigger event type, number of resource distribution machines within the geographic area, landing time of the trigger event, etc.) and single or multiple independent (interdependent) variables or predictors that impact the target variable. Regression analysis may also be used to determine how much the predictors influence a target variable.

By taking into account the historical performance of the resource distribution machines within a geographic location/region during past instances of specific trigger events, the present invention provides the functional benefit of predicting a quantity of resources that must be distributed to the resource distribution machines and the frequency at which the resources must be distributed to the resource distribution machines within the geographic location/region associated with the trigger event. In this way, the present invention ensures that the number of lack of resources notification displayed by the resource distribution machines and the aggregate quantity of resources deemed unavailable during the occurrence of the trigger event are minimized.

In some embodiments, the system may be configured to transmit control signals configured to cause one or more computing devices associated with one or more resource computing terminals located within a predetermined geographic distance from the one or more resource distribution machines to display the predicted frequency at which one or more additional resources need to be added to the one or more resource distribution machines and quantity of the one or more additional resources that need to be added to the one or more resource distribution machines during the one or more time periods associated with the one or more trigger events. In some embodiments, the one or more resource computing terminals may include one or more repositories configured to store the one or more resources.

In some embodiments, the system may be configured to initiate a transmission of the predicted quantity of the one or more additional resources from the one or more resource computing terminals to the one or more resource distribution machines at the predicted frequency. In response, the system may be configured to electronically receive, from the one or more resource computing terminals, an indication that the predicted quantity of the one or more additional resources have been transmitted from the one or more resource computing terminals to the one or more resource distribution machines at the predicted frequency.

In embodiments where the user interacts with the one or more resource distribution machines for resource distribution purposes, the system may be configured to electronically receive, via the one or more resource distribution machines, a request to distribute the one or more resources to a user. In response, the system may be configured to transmit, via a display device associated with the one or more resource distribution machines, an authentication request. In response to the authentication request, the system may be configured to electronically receive, via the one or more resource distribution machines, one or more authentication credentials associated with the user in response to the authentication request. Based on the authentication credentials, the system may be configured to validate the one or more authentication credentials associated with the user to verify an identity of the user. In response, the system may be configured to authorize distribution of the one or more resources, via the one or more resource distribution machines, to the user based on at least a successful verification of the identity of the user.

As will be appreciated by one of ordinary skill in the art in view of this disclosure, the present invention may include and/or be embodied as an apparatus (including, for example, a system, machine, device, computer program product, and/or the like), as a method (including, for example, a business method, computer-implemented process, and/or the like), or as any combination of the foregoing. Accordingly, embodiments of the present invention may take the form of an entirely business method embodiment, an entirely software embodiment (including firmware, resident software, micro-code, stored procedures in a database, or the like), an entirely hardware embodiment, or an embodiment combining business method, software, and hardware aspects that may generally be referred to herein as a “system.” Furthermore, embodiments of the present invention may take the form of a computer program product that includes a computer-readable storage medium having one or more computer-executable program code portions stored therein. As used herein, a processor, which may include one or more processors, may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

One or more computer-executable program code portions for carrying out operations of the present invention may include object-oriented, scripted, and/or unscripted programming languages, such as, for example, Java, Perl, Smalltalk, C++, SAS, SQL, Python, Objective C, JavaScript, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F #.

Some embodiments of the present invention are described herein with reference to flowchart illustrations and/or block diagrams of apparatus and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a transitory and/or non-transitory computer-readable medium (e.g. a memory) that can direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present invention.

Although many embodiments of the present invention have just been described above, the present invention may be embodied in many different forms and should not be construed as limited to the embodiments set forth herein; rather, these embodiments are provided so that this disclosure will satisfy applicable legal requirements. Also, it will be understood that, where possible, any of the advantages, features, functions, devices, and/or operational aspects of any of the embodiments of the present invention described and/or contemplated herein may be included in any of the other embodiments of the present invention described and/or contemplated herein, and/or vice versa. In addition, where possible, any terms expressed in the singular form herein are meant to also include the plural form and/or vice versa, unless explicitly stated otherwise. Accordingly, the terms “a” and/or “an” shall mean “one or more,” even though the phrase “one or more” is also used herein. Like numbers refer to like elements throughout.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

What is claimed is:

1. A system for intelligent factor based resource distribution machine loading, the system comprising:
at least one non-transitory storage device; and
at least one processing device coupled to the at least one non-transitory storage device, wherein the at least one processing device is configured to:
electronically receive information associated with one or more trigger events, wherein the one or more trigger events is associated with one or more time periods, wherein the one or more trigger events is associated with a predetermined geographic region;
establish a communication link with one or more resource distribution machines located within the predetermined geographic region associated with the one or more trigger events;
electronically receive, via the communication link, information associated with the one or more resource distribution machines, wherein the resource distribution machines are associated with one or more resources;
implement one or more machine learning algorithms on the information associated with the one or more resource distribution machines and the information associated with the one or more trigger events; and
predict a frequency at which one or more additional resources need to be added to the one or more resource distribution machines and quantity of the one or more additional resources that need to be added to the one or more resource distribution machines during the one or more time periods associated with the one or more trigger events based on at least implementing the one or more machine learning algorithms.

2. The system of claim 1, wherein the information associated with the one or more trigger events comprises an average time period from a first time an occurrence of the one or more trigger events is predicted to occur to a second time the one or more trigger events occurs, a classification associated with the one or more trigger events, and an average time period associated with the one or more trigger events.

3. The system of claim 2, wherein the information associated with the one or more resource distribution machines comprises an average resource quantity available for distribution via the one or more resource distribution machines from the first time the occurrence of the one or more trigger events is predicted to occur to a third time an average predetermined time period after the one or more trigger events has concluded, a frequency at which the one or more resources were distributed via the one or more resource distribution machines during the time period between the first time and the third time, an average resource quantity distributed via the one or more resource distribution machines during the time period between the first time and the third time, an average number of users accessing the one or more resource distribution machines for distribution of the one or more resources during the time period between the first time and the third time, and an average number of resource distribution machines located within the predetermined geographic region associated with the one or more trigger events.

4. The system of claim 1, wherein the at least one processing device is further configured to:
transmit control signals configured to cause one or more computing devices associated with one or more resource computing terminals located within a predetermined geographic distance from the one or more resource distribution machines to display the predicted frequency at which one or more additional resources need to be added to the one or more resource distribution machines and quantity of the one or more additional resources that need to be added to the one or more resource distribution machines during the one or more time periods associated with the one or more trigger events.

5. The system of claim 4, wherein the at least one processing device is further configured to:
initiate a transmission of the predicted quantity of the one or more additional resources from the one or more resource computing terminals to the one or more resource distribution machines at the predicted frequency; and
electronically receive, from the one or more resource computing terminals, an indication that the predicted quantity of the one or more additional resources have been transmitted from the one or more resource computing terminals to the one or more resource distribution machines at the predicted frequency.

6. The system of claim 1, wherein the one or more trigger events comprises at least one or more incidents of mass trauma.

7. The system of claim 6, wherein the one or more trigger events comprises one or more trigger event types, wherein the one or more trigger event types comprises at least an economic crisis, a natural disaster, a technological disaster, and/or a man-made disaster.

8. The system of claim 1, wherein the at least one processing device is further configured to:
electronically receive, via the one or more resource distribution machines, a request to distribute the one or more resources to a user;
transmit, via a display device associated with the one or more resource distribution machines, an authentication request;
electronically receive, via the one or more resource distribution machines, one or more authentication credentials associated with the user in response to the authentication request;
validate the one or more authentication credentials associated with the user to verify an identity of the user; and
authorize distribution of the one or more resources, via the one or more resource distribution machines, to the user based on at least a successful verification of the identity of the user.

9. A computerized method for intelligent factor based resource distribution machine learning, the method comprising:
electronically receiving information associated with one or more trigger events, wherein the one or more trigger events is associated with one or more time periods, wherein the one or more trigger events is associated with a predetermined geographic region;
establishing a communication link with one or more resource distribution machines located within the predetermined geographic region associated with the one or more trigger events;
electronically receiving, via the communication link, information associated with the one or more resource distribution machines, wherein the resource distribution machines are associated with one or more resources;
implementing one or more machine learning algorithms on the information associated with the one or more resource distribution machines and the information associated with the one or more trigger events; and
predicting a frequency at which one or more additional resources need to be added to the one or more resource distribution machines and quantity of the one or more additional resources that need to be added to the one or more resource distribution machines during the one or more time periods associated with the one or more trigger events based on at least implementing the one or more machine learning algorithms.

10. The method of claim 9, wherein the information associated with the one or more trigger events comprises an average time period from a first time an occurrence of the one or more trigger events is predicted to occur to a second time the one or more trigger events occurs, a classification associated with the one or more trigger events, and an average time period associated with the one or more trigger events.

11. The method of claim 10, wherein the information associated with the one or more resource distribution machines comprises an average resource quantity available for distribution via the one or more resource distribution machines from the first time the occurrence of the one or more trigger events is predicted to occur to a third time an average predetermined time period after the one or more trigger events has concluded, a frequency at which the one or more resources were distributed via the one or more resource distribution machines during the time period between the first time and the third time, an average resource quantity distributed via the one or more resource distribution machines during the time period between the first time and the third time, an average number of users accessing the one or more resource distribution machines for distribution of the one or more resources during the time period between the first time and the third time, and an average number of resource distribution machines located within the predetermined geographic region associated with the one or more trigger events.

12. The method of claim 9, wherein the method further comprises:
transmitting control signals configured to cause one or more computing devices associated with one or more resource computing terminals located within a predetermined geographic distance from the one or more resource distribution machines to display the predicted frequency at which one or more additional resources need to be added to the one or more resource distribution machines and quantity of the one or more additional resources that need to be added to the one or more resource distribution machines during the one or more time periods associated with the one or more trigger events.

13. The method of claim 12, wherein the method further comprises:
initiating a transmission of the predicted quantity of the one or more additional resources from the one or more resource computing terminals to the one or more resource distribution machines at the predicted frequency; and
electronically receiving, from the one or more resource computing terminals, an indication that the predicted quantity of the one or more additional resources have been transmitted from the one or more resource computing terminals to the one or more resource distribution machines at the predicted frequency.

14. The method of claim 9, wherein the one or more trigger events comprises at least one or more incidents of mass trauma.

15. The method of claim 14, wherein the one or more trigger events comprises one or more trigger event types, wherein the one or more trigger event types comprises at least an economic crisis, a natural disaster, a technological disaster, and/or a man-made disaster.

16. The method of claim 9, wherein the method further comprises:
electronically receiving, via the one or more resource distribution machines, a request to distribute the one or more resources to a user;
transmitting, via a display device associated with the one or more resource distribution machines, an authentication request;
electronically receiving, via the one or more resource distribution machines, one or more authentication credentials associated with the user in response to the authentication request;
validating the one or more authentication credentials associated with the user to verify an identity of the user; and
authorizing distribution of the one or more resources, via the one or more resource distribution machines, to the user based on at least a successful verification of the identity of the user.

17. A computer program product for intelligent factor based resource distribution loading, the computer program product comprising a non-transitory computer-readable medium comprising code causing a first apparatus to:
electronically receive information associated with one or more trigger events, wherein the one or more trigger events is associated with one or more time periods, wherein the one or more trigger events is associated with a predetermined geographic region;
establish a communication link with one or more resource distribution machines located within the predetermined geographic region associated with the one or more trigger events;
electronically receive, via the communication link, information associated with the one or more resource distribution machines, wherein the resource distribution machines are associated with one or more resources;
implement one or more machine learning algorithms on the information associated with the one or more resource distribution machines and the information associated with the one or more trigger events; and
predict a frequency at which one or more additional resources need to be added to the one or more resource distribution machines and quantity of the one or more additional resources that need to be added to the one or more resource distribution machines during the one or more time periods associated with the one or more trigger events based on at least implementing the one or more machine learning algorithms.

18. The computer program product of claim 17, wherein the information associated with the one or more trigger events comprises an average time period from a first time an occurrence of the one or more trigger events is predicted to occur to a second time the one or more trigger events occurs, a classification associated with the one or more trigger events, and an average time period associated with the one or more trigger events.

19. The computer program product of claim 18, wherein the information associated with the one or more resource distribution machines comprises an average resource quantity available for distribution via the one or more resource distribution machines from the first time the occurrence of the one or more trigger events is predicted to occur to a third time an average predetermined time period after the one or more trigger events has concluded, a frequency at which the one or more resources were distributed via the one or more resource distribution machines during the time period between the first time and the third time, an average resource quantity distributed via the one or more resource distribution machines during the time period between the first time and the third time, an average number of users accessing the one or more resource distribution machines for distribution of the one or more resources during the time period between the first time and the third time, and an average number of resource distribution machines located within the predetermined geographic region associated with the one or more trigger events.

20. The computer program product of claim 17, wherein the first apparatus is further configured to:
transmit control signals configured to cause one or more computing devices associated with one or more resource computing terminals located within a predetermined geographic distance from the one or more resource distribution machines to display the predicted frequency at which one or more additional resources need to be added to the one or more resource distribution machines and quantity of the one or more additional resources that need to be added to the one or more resource distribution machines during the one or more time periods associated with the one or more trigger events.
